(19) United States
(12) Patent Application Publication
(10) Pub. No.: US 2015/0112695 A1
(43) Pub. Date: Apr. 23, 2015

(54) SYSTEM AND METHOD FOR MANAGING CLINICAL TREATMENT DISPENSATION

(71) Applicant: Medidata Solutions, Inc., New York, NY (US)

(72) Inventors: Jonathan Lebowitsch, Brooklyn, NY (US); Christine Matakovich, Spring Mount, PA (US); Benjamin Young, Manlius, NY (US); Ian Harrington, Brooklyn, NY (US); Christopher Herbst, Brooklyn, NY (US)

(73) Assignee: Medidata Solutions, Inc., New York, NY (US)

(21) Appl. No.: 14/057,668

(22) Filed: Oct. 18, 2013

(51) Int. Cl. G06F 19/00

(52) U.S. Cl. CPC G06F 19/3456
USPC 705/2

(57) ABSTRACT

A system for managing clinical treatment dispensation includes a rules engine and a treatment assignment subsystem. The rules engine is capable of receiving at least two treatment parameters from at least one treatment module and uses the treatment parameters to compute a set of treatment combinations. The treatment assignment subsystem uses the treatment combinations set to generate treatment dispensation information useful for treating a patient. A method for generating a clinical treatment dispensation design is also described.

### BACKGROUND

A clinical trial is often performed before the introduction of a new drug or treatment (i.e., therapy), to test the safety and efficacy of the therapy for human consumption. Clinical trials are usually classified into four phases: Phase I generally comprises safety screening on a small group of people, Phase II comprises efficacy screening, Phase III comprises safety screening on a larger group of people, and Phase IV comprises additional studies during an initial sales period.

The guidelines and procedural methods for administration of a clinical trial are known as clinical trial protocols. Clinical trial protocols often determine how subjects will be selected for a trial, how many geographic locations will participate in the trial, and standardized laboratory methods for how test results will be studied during the trial, among other things. In some cases, clinical trial protocols are comparative, i.e., they are set to compare the outcomes of different therapies, and include randomization, the random allocation of subjects to various study arms, where each arm corresponds to one of the therapies being compared. Such randomization is often designed to minimize a clinical trial administrator's bias while enrolling subjects or while allocating therapy to specific subjects or patients.

Often the study design allows or even mandates variability in the doses within an arm. The variability can be of two types: (i) variability across different subjects belonging to the same study arm, for example when dosing is based on weight, and/or (ii) variability across different visits of the same subject during the trial, based on some clinical finding (such as a change in tolerability) or on a scheduled dose titration. If a clinical trial designer or physician desires to change dosages throughout the study, or if the desired dosing for a therapy changes during a clinical trial, these desired changes can be extremely difficult to capture and implement globally for all, or individual, subjects across the study, as implementation of such changes may be time consuming and possess a high error rate. Furthermore, a clinical trial protocol may include complex rules for whether specific dosing changes are allowed. These rules can be difficult to implement globally and often require complex recordkeeping.

### BRIEF DESCRIPTION OF THE DRAWINGS

FIG. 1A is a block diagram of a system for treating patients, including a dispensation design system and a runtime system, according to an embodiment of the present invention;

FIG. 1B is a more detailed block diagram of FIG. 1A, showing the components of the dispensation design and runtime systems, according to an embodiment of the present invention;

FIGS. 1C-1E are block diagrams of subsystems within the system of FIG. 1B, according to embodiments of the present invention;

FIG. 2A is an example of a treatment design interface to configure a treatment design for a clinical trial, according to an embodiment of the present invention;

FIG. 2B is an example of an interface used to configure titrations within a treatment design of a clinical trial, according to an embodiment of the present invention;

FIG. 2C is an example of an interface used to configure a study visit schedules subsystem, according to an embodiment of the present invention;

FIG. 2D is an example of a treatment assignment user interface, according to an embodiment of the present invention;

FIG. 2E is an excerpt from a clinical trial design specification, according to an embodiment of the present invention; and

FIG. 3 is a flowchart of a system for configuring a treatment design for a clinical trial, according to an embodiment of the present invention.

Where considered appropriate, reference numerals may be repeated among the drawings to indicate corresponding or analogous elements. Moreover, some of the blocks depicted in the drawings may be combined into a single function.

### DETAILED DESCRIPTION

In the following detailed description, numerous specific details are set forth in order to provide a thorough understanding of embodiments of the invention. However, it will be understood by those of ordinary skill in the art that the embodiments of the present invention may be practiced without these specific details. In other instances, well-known methods, procedures, components, and circuits have not been described in detail so as not to obscure the present invention.

Embodiments of a computerized clinical treatment system have been developed that may configure, integrate, and store numerous variables and components for use in clinical trials and other clinical treatment settings. Such systems may streamline the design and overall management of clinical treatment dispensation. Embodiments may also integrate features and systems for randomization, inventory management, dose scheduling, and electronic data capture, for example. The clinical treatment system may be implemented as a standalone program or may be implemented on a network, for example, over the Internet as a cloud-based service or hosted service, which may be accessed through a standard web service API (application programming interface).

An example of a clinical treatment system is a system that helps design and administer clinical trials. A sponsor (e.g., a drug manufacturer whose drug is being tested) or a contract research organization (CRO), which may execute clinical trials on behalf of a sponsor, may develop a protocol for a clinical trial. The clinical trial protocol may include a dosing schedule to specify when, and how much of, a therapy is to be administered to clinical trial subjects as well as dosing factors that influence what dosage a subject may receive. In some cases, clinical trials may include graduated or conditional dosing schedules that alter the prescribed therapy dose as the clinical trial progresses, a process known as titration. Titration may be based on scheduled or unscheduled physician visits or on specific conditional rules or both. Dosing information from the clinical trial protocol may be used to develop a detailed visit schedule, which often includes a schedule of every combination of every treatment arm according to each dosing factor and titration level detailed in the clinical trial protocol. Such a schedule may comprise tens of thousands of combinations that require hours of labor to create corresponding rows and columns in visit schedule spreadsheets. Upon completion of such a visit schedule spreadsheet, a clinical trial sponsor or CRO may spend several hours on quality control to validate the visit schedule for accuracy. A developer with computer programming skills then must hard code the details of the visit schedule into a computerized clinical trial system for clinical trial site personnel to use. Such complexities lead to error-prone designs and can extend the clinical trial development time by several weeks or longer, resulting in substantially increased costs. Additionally, severe risks to patients may be involved when errors occur in the subject treatment assignment, compromising study integrity.

In order to decrease clinical trial design error rates and corresponding patient risk, decrease time spent on coding and development, and decrease overall cost of clinical trial design, a system has been developed that implements dosing, schedule, and titration rules globally and individually within a clinical trial (or other clinical treatment) protocol, and may modify and customize a clinical trial's dosing, schedule, and titration settings in real-time, without requiring additional hours of custom coding and development. With the system as described herein, clinical trial and treatment designers may capture, implement, and manage complex dispensation requirements for clinical trials and treatments.

Embodiments of the invention enable a designer to enter, manipulate, and implement dosing, schedule, and titration parameters including treatment arms, dosing factors, dosing levels, scheduled and unscheduled titrations, titration limiting rules, and treatment assignment rules, among others. Embodiments of the invention also include a rules engine that automatically computes clinical trial protocol information for use in a treatment assignment subsystem that may generate every combination of every treatment arm according to each dosing factor, dosing level, schedule, and titration. A runtime system may also be included that clinical trial site personnel may use to store and obtain dispensation information and input dispensation requests and patients' responses to treatment.

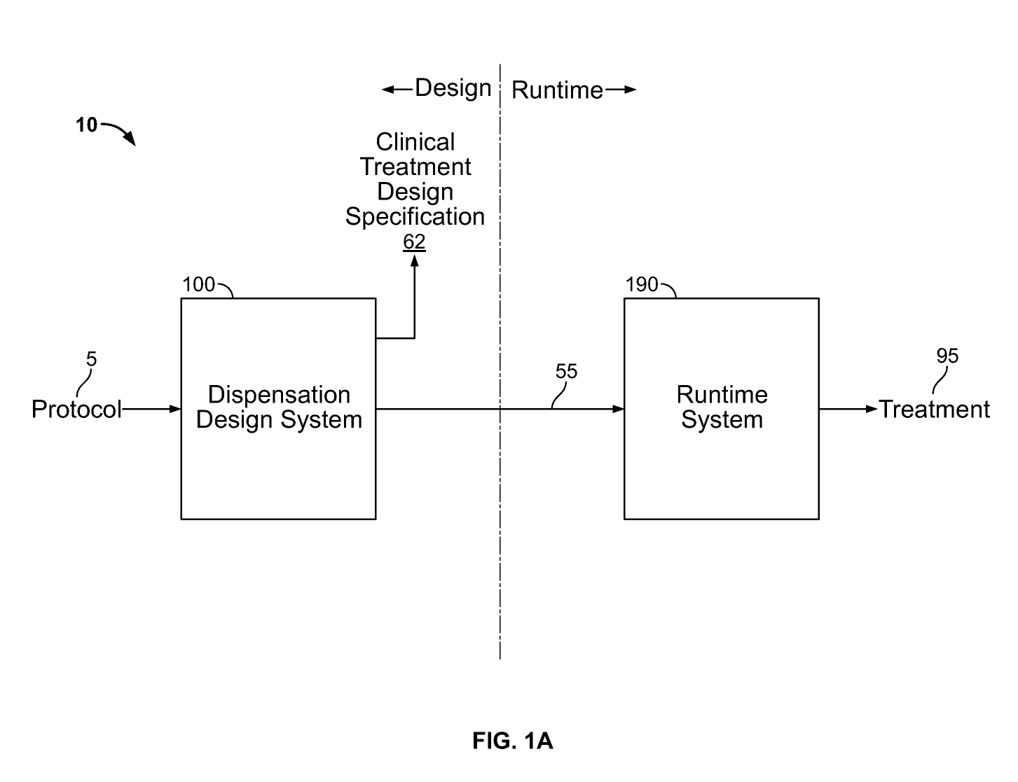

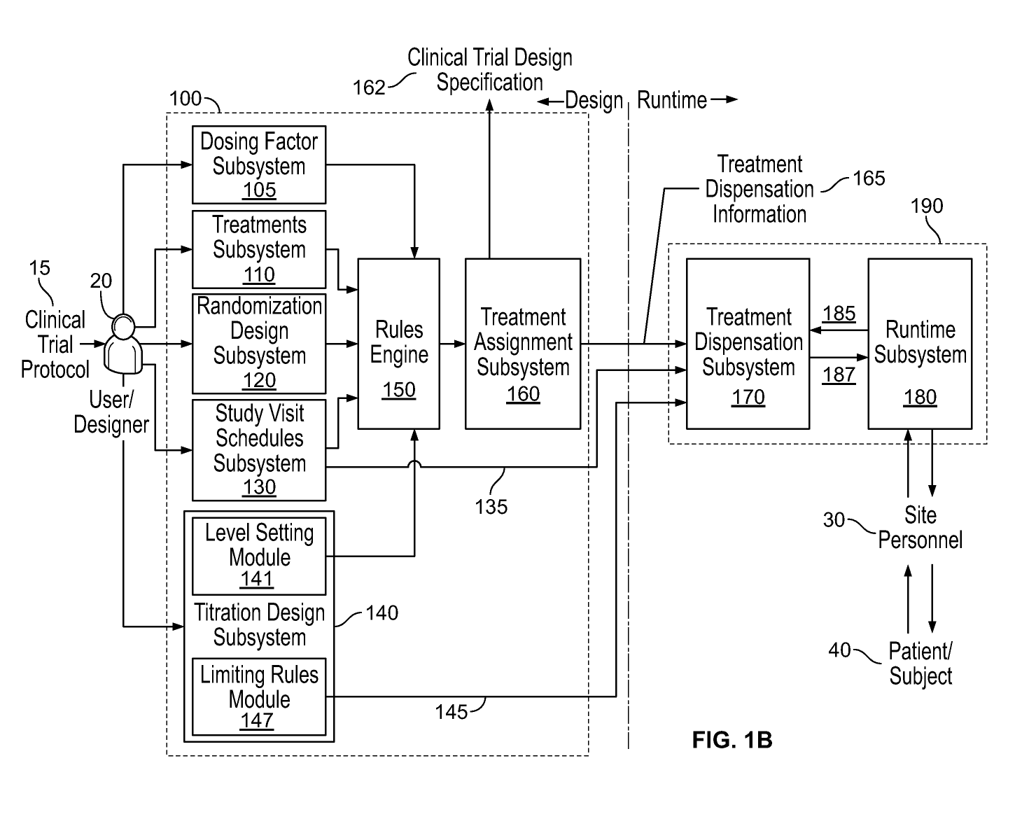

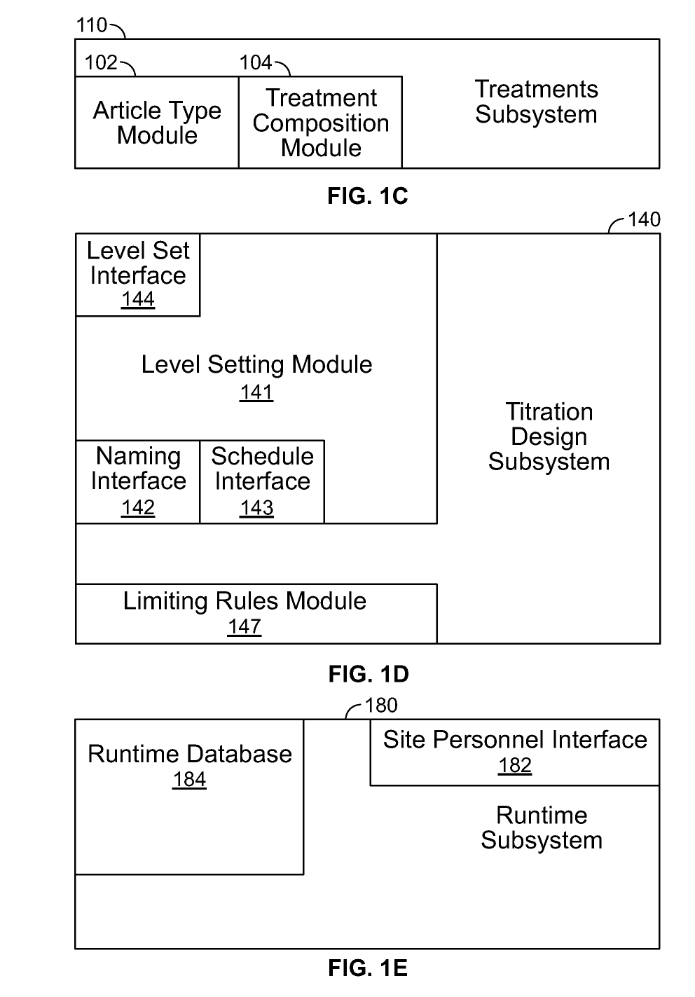

Reference is now made to FIG. 1A, which is a block diagram of a system 10 for treating patients that may include both design and runtime components, according to an embodiment of the present invention. The design component may include dispensation design system 100, and the runtime component may include runtime system 190. System 10 may be used to manage clinical treatment dispensation for a patient based on a protocol 5. Protocol 5 may be input to dispensation design system 100, which may produce clinical treatment design specification (or configuration report) 62 as well as treatment dispensation information. Treatment dispensation information may be included as part of data 55 that are transmitted to runtime system 190, which may provide a treatment (or treatment plan) 95 for the patient. System 10 may be used in a number of clinical settings.

Reference is now made to FIG. 1B, which is a more detailed block diagram of FIG. 1A, according to an embodiment of the present invention. This embodiment uses a clinical trial as an example of one of the clinical treatment settings in which system 10 may operate. Shown in FIG. 1B are dispensation design system 100 on the “design” side of the dotted line and runtime system 190 on the “runtime” side of the dotted line. Data 55 may include treatment dispensation information 165 as well as information 135 about the schedule and titration history of each subject.

In FIG. 1B, dispensation design system 100 may generate clinical trial design specification 162 and treatment dispensation information 165 based on clinical trial protocol 15, which is an example of protocol 5 shown in FIG. 1A. Dispensation design system 100 may include rules engine 150 that may use inputs from several subsystems (or treatment modules) to determine treatment combinations that drive an interactive, configurable treatment assignment subsystem 160. The input subsystems may include dosing factor subsystem 105, treatments subsystem 110, randomization design subsystem 120, study visit schedules subsystem 130, and titration design subsystem 140, among others. The input subsystems utilize treatment parameters input by designer 20, including, but not limited to, dosing factors, therapy article types, combinations of therapies (including therapy compositions), visit schedules, randomization information, titration levels and titration rules.

Rules engine 150 may utilize treatment parameters to compute treatment combinations to drive treatment assignment subsystem 160. In turn, treatment assignment subsystem 160 may be used by designer 20 to generate clinical trial design specification (or configuration report) 162, as well as treatment dispensation information 165, which may be used to configure treatment dispensation system 170, which, along with runtime subsystem 180, is part of runtime system 190. Although clinical trial design specification 162 is depicted in FIG. 1B as emanating from treatment assignment subsystem 160, clinical trial design specification 162 encompasses settings entered via all of subsystems 105-160, not just those entered in subsystem 160. During a clinical treatment (or during a clinical trial), site personnel 30 may interact with runtime subsystem 180 in order to determine proper dispensation to subject or patient 40. Runtime subsystem 180 may comprise a database, a user interface, and other features to relay subject data and runtime titration information to, and obtain dispensation instructions from, treatment dispensation system 170, as shown by arrows 185 and 187.

Dosing factor subsystem 105 may be used to allow a designer 20 to set up additional dosing parameters that help determine appropriate treatment for the subject or patient. Dosing factors may comprise clinical factors such as a patient's gender, weight, or body surface area, or may comprise more abstract factors like a patient's dosing level, or a combination of both. In one embodiment, dosing factors may include factors for randomization.

Treatments subsystem 110 may be used to assign types of therapies and combinations of therapies, for example. As shown in FIG. 1C, treatments subsystem 110 may include several modules, including article type module 102 and treatment composition module 104. Article type module 102 may allow designer 20 to designate the type of therapy administered during the clinical trial, including the therapy's chemical or manufacturing composition. Treatment composition module 104 may allow designer 20 to designate groups of inventory items that may be dispensed together to a subject in a single transaction during the trial. Treatment composition module 104 may also include a setting to select a “Do Not Dispense” value, which may be the number of days inventory items should have before expiring.

In another embodiment, randomization factors may be provided by randomization design subsystem 120. Titration design subsystem 140 may allow designer 20 to implement titrations and titration rules into the clinical trial design specification.

As shown in FIG. 1D, titration design subsystem 140 may include several modules, including level setting module 141 and limiting rules module 147, among others. Level setting module 141 may allow designer 20 to configure titration levels that rules engine 150 may use to drive treatment assignment subsystem 160 or generate clinical trial design specification 162. Level setting module 141 may include naming interface 142, schedule interface 143, and level set interface 144.

Naming interface 142 may enable specific titration level sets to be identified by name. Embodiments of this feature may allow titration level sets to be implemented into treatment assignment subsystem 160 and identified accordingly. Schedule interface 143 may allow designer 20 to implement a scheduled or unscheduled titration design into treatment assignment subsystem 160. Level set interface 144 may allow designer 20 to implement specific titration levels into the dispensation design system.

For a clinical trial including a scheduled titration design, level set interface 144 may interact with study visit schedules subsystem 130, shown in FIG. 1B, to generate titration levels automatically across scheduled visits. Study visit schedules subsystem 130 also may allow designer 20 to manually change titration levels across the clinical trial, or add or remove visits from the visitation schedule. Study visit schedules subsystem 130 may also enable designer 20 to define the type of visit (e.g., dosing or non-dosing), set the interval number of days between visits, and set acceptable deviations from the visit intervals.

For a trial with an unscheduled titration design, level set interface 144 may interact with study visit schedules subsystem 130 to assign a default titration level to an initial patient visit. In this case, dosing may continue to be dispensed according to default titration levels unless the clinical trial implements conditions or requests to titrate to another level. Generally, unscheduled titrations implement a titration level change based on conditions outside of the number of a patient's visits, or the physician's discretion. Unscheduled titration conditions may be pre-defined or designated by the clinical trial designer.

Embodiments of system 100 may incorporate conditional titration rules through limiting rules module 147, which may be used to govern the number of unscheduled titrations for one or more subjects in the clinical trial. For example, these rules may be applicable to visits in which a clinical factor, such as a subject's weight or reaction to the therapy, or physician discretion, dictates unscheduled titrations. Limiting rules module 147 and the rules therein may control unscheduled titrations both in the case of unscheduled titration design, where all the titrations are unscheduled, and in the case of scheduled titration design, where unscheduled titrations—deviations from the titration schedule—may be allowed or mandated.

Level set interface 144 may allow a clinical trial designer to implement titration levels or specific dosing values across the clinical trial visit schedule. Titration level sets often comprise an ordered set of increasing titration levels. Titration level sets may be ordered and numbered, with the first level as the lowest dosing value, and successive levels as incremental steps up from each value. For example, a designer could set three titration levels in a titration level set with three levels where Level 1 may be 3 mg/kg, Level 2 may be 6 mg/kg and Level 3 may be 9 mg/kg.

Limiting rules module 147 may allow system 100 to implement rules that limit dosing from titrating up or down. Titrating up (“up-titration”) increases the subject's titration by one level. Titrating down (“down-titration”) decreases the subject's titration by one level. Other types of conceived rules may include rules to “maintain” or “use default.” A request to “maintain” may continue the subject at the same titration level regardless of any up-titrations or down-titrations scheduled for a visit. A request to “use default” may result in the dosage to be dispensed in accordance with the schedule, if one exists. Examples of titration limiting rules embodied in limiting rules module 147 may include at least the following:

Example Rule 1: The number of times a subject can titrate up outside of a primary treatment design. If a designer activates this rule and enters a number, the designer may prevent subjects from being titrated up off-schedule more times than the number specified. If Example Rule 1 is selected and a request arrives to titrate up a subject after the maximum number of times has already been reached, the system may maintain the current titration level. Optional responses include returning an error message or dispensing a titration according to the current titration level. In one embodiment, Example Rule 1 may allow scheduled or unscheduled down-titrations to occur for subjects that have reached a maximum number of up-titrations.

Example Rule 2: The number of times a subject can titrate down outside of the primary treatment design. If a designer activates this rule and enters a number, the designer may prevent subjects from being titrated down off-schedule more times than the number specified. If Example Rule 2 is selected and a request arrives to titrate down a subject after the maximum number of times has already been reached, the system may maintain the current titration level. Optional responses include returning an error message or dispensing a titration according to the current titration level. In one embodiment, Example Rule 2 may allow scheduled or unscheduled up-titrations to occur for subjects that have reached a maximum number of down-titrations.

Example Rule 3: The number of times a subject can titrate up or down outside of the primary treatment design. If a designer activates this rule and enters a number, the system may prevent subjects from being titrated up or down off-schedule more times than the number specified. If Example Rule 3 is selected and a request arrives to titrate after the maximum number of times has already been reached, the rule may instruct the software to maintain the current titration level. Optional responses include returning an error message or dispensing a titration according to the current titration level. In one embodiment, scheduled titrations are not counted. If a subject has reached the maximum number of unscheduled titrations they may be maintained for the remainder of the study, regardless of future scheduled titrations.

Example Rule 4: If a subject maintains a titration level during a scheduled visit, count as an up or down titration. If a designer activates this rule, the system may count any request to maintain the subject's titration level as an up-titration if a down-titration was scheduled. Conversely, the system may maintain the subject's titration level as a down-titration if an up-titration was scheduled.

Example Rule 5: Enforce single step titration. If a designer activates this rule, the system may prevent titration level selections that are more than one level up or down from the previously selected titration level. In some embodiments, the system may ensure subjects are only titrated one level up or down in the direction of the desired titration.

Example Rule 6: Determine system reaction if upper or lower titration level limits are reached. A designer can use this rule to select how the system will react to a request to up-titrate above a maximal level, down-titrate below a minimal level, or titrate in a manner in conflict with Example Rules 1-3. Example Rule 6 may allow the designer to select between maintaining a current titration level or return an error.

After all desired treatment parameters have been entered into the modules described above, rules engine 150 may compute a treatment combination set configurable by treatment assignment subsystem 160, including all combinations of treatment parameters based on treatment arms, dosing levels, titration rules, and scheduled visits, among others. Rules engine 150 may operate by creating rules based on treatment parameters and applying them globally to map every possible combination. As an example, rules engine 150 may create rules by multiplying the number of treatment arms by the numbers of scheduled visits and dosing levels to generate all possible combinations of treatment dispensation during the clinical trial. Rules engine 150 may then translate these combinations into rules that may be selectively assigned in groups across multiple treatment arms and visits by treatment assignment subsystem 160. Such assignment may reduce tens of thousands of applied treatment combinations into a handful of rules that may be assigned globally to automatically generate clinical trial design specification 162 and provide information to runtime system 190 (including treatment dispensation subsystem 170 and runtime subsystem 180).

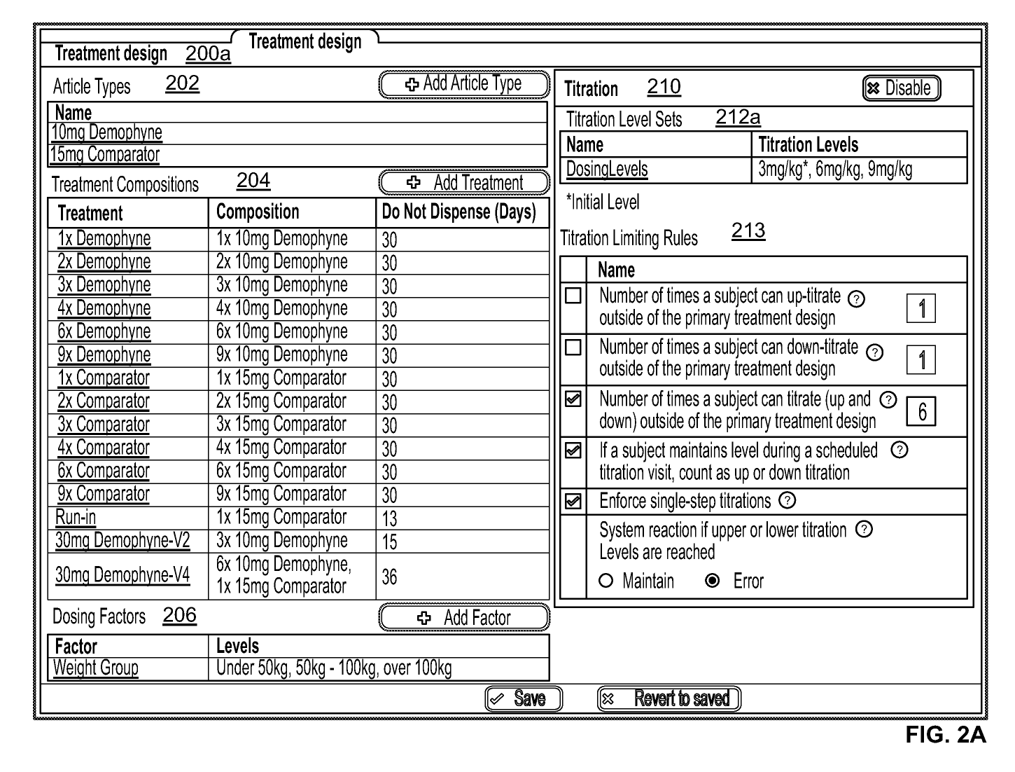

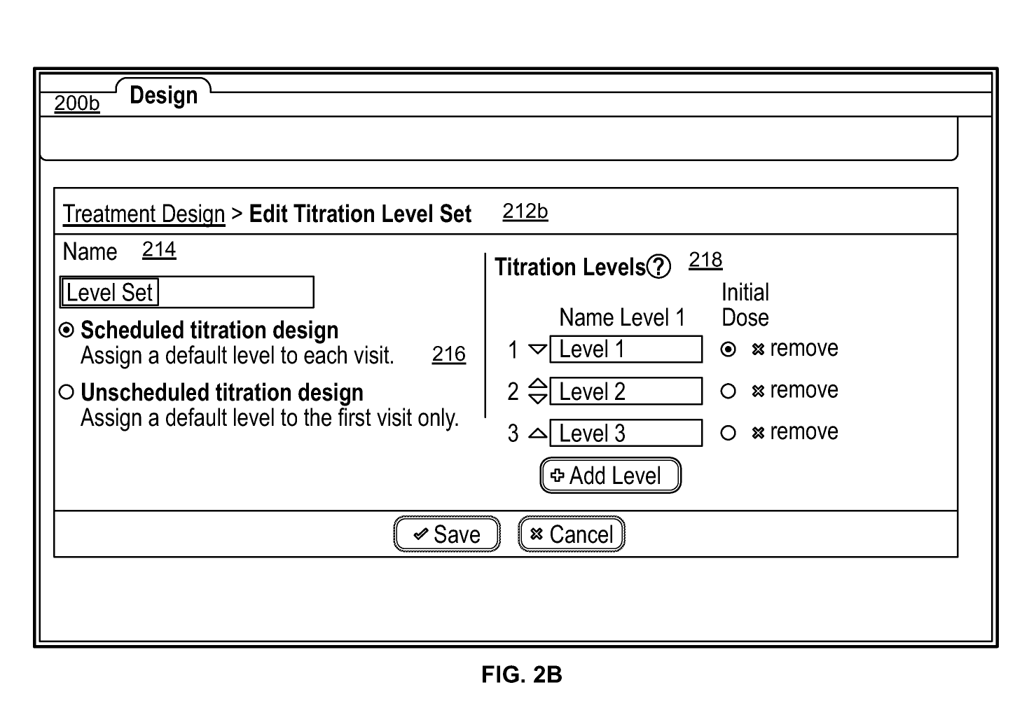

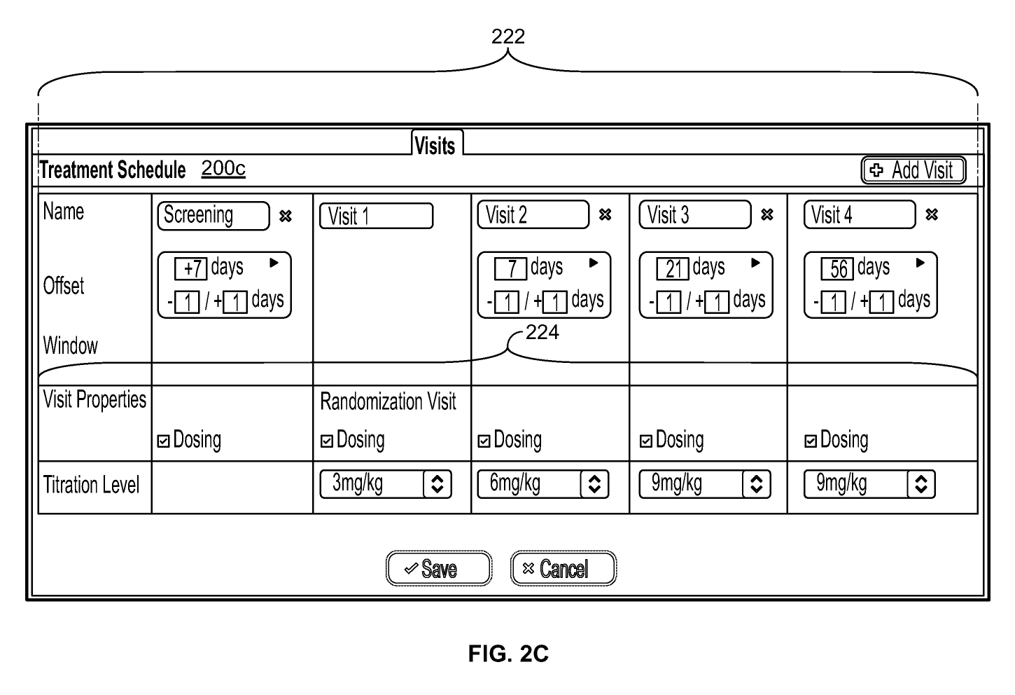

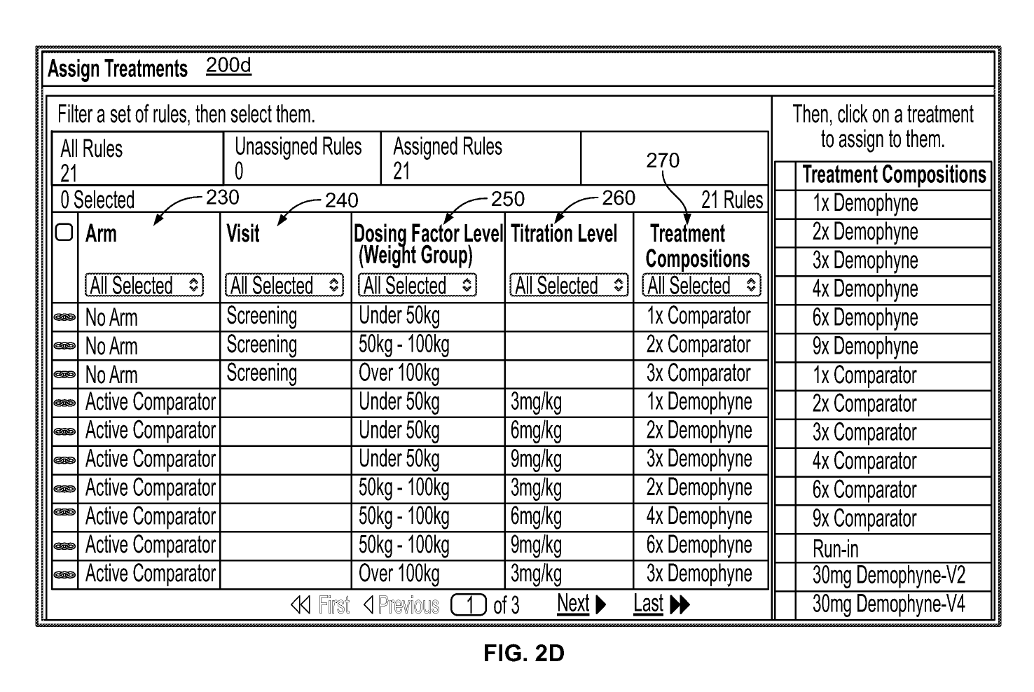

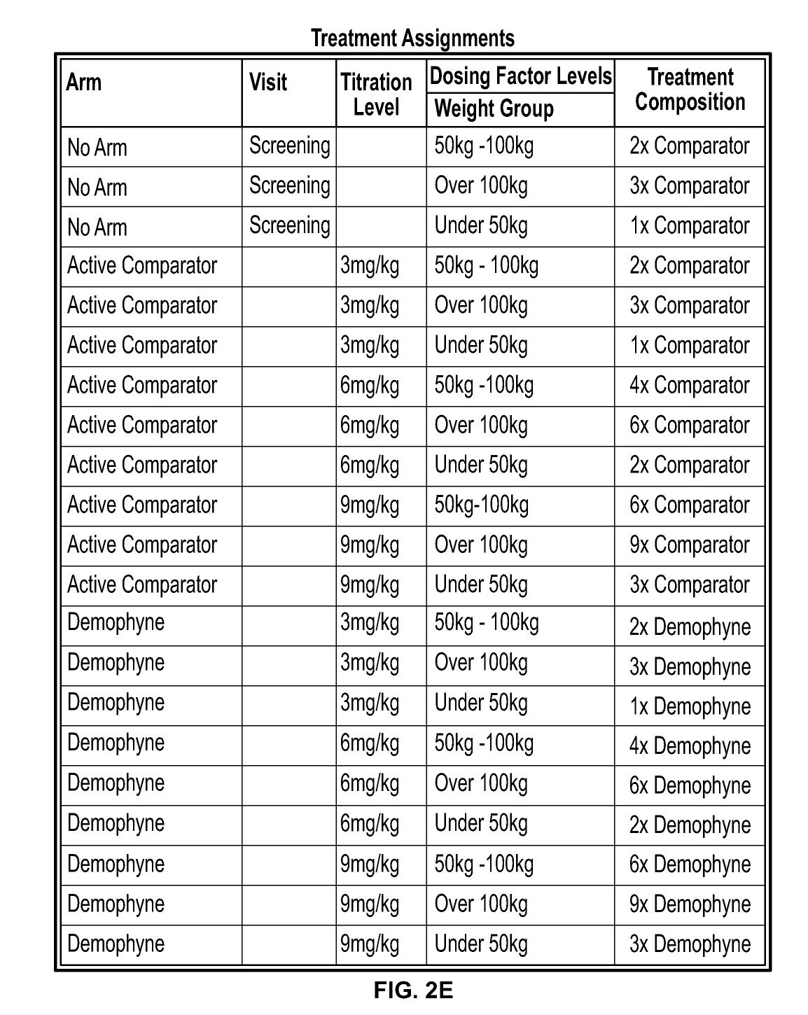

As discussed above, after rules engine 150 generates treatment combinations based on information from input subsystems and provides the combination to treatment assignment subsystem 160, a designer may configure treatment assignment subsystem 160 according to clinical trial protocol 15. Designer 20 may specifically configure treatment parameters within the treatment combination set by filtering and assigning specific treatments to arms, dosing factors, titration levels, and visits, for example, pursuant to clinical trial protocol 15. Treatment assignment subsystem 160 may include filtering and multi-selection capabilities that may allow designer 20 to isolate specific treatment parameters of the clinical trial and implement rules as desired. Treatment assignment subsystem 160 may be automatically configured by rules engine 150 to capture every treatment parameter combination and may prevent designer 20 from configuring treatment dispensation information contrary to rules implemented in clinical trial protocol 15. For example, designer 20 may designate as invalid specific combinations of segments (arms), visits, and levels of each dosing factor by filtering out such invalid combinations. In another embodiment of the invention, treatment assignment subsystem 160 may automatically invalidate specific conditional combinations that are improper. Once designer 20 completes configuration of treatment assignment subsystem 160, system 100 may generate clinical trial design specification or configuration report 162. Specification 162 may be a paper printout or digital copy of a treatment dispensation schedule, although additional information may also be included. Part of a clinical trial design specification is shown in FIG. 2E and will be discussed below.

As shown in FIG. 1B, once a clinical trial has begun, pursuant to clinical trial protocol 15 and treatment assignment subsystem 160, site personnel 30 at the clinical trial may interact with runtime subsystem 180 to obtain dispensation information and to input dispensation requests. In some embodiments of the invention, runtime subsystem 180 may conduct two-way communication with treatment dispensation subsystem 170. Treatment assignment subsystem 160 may communicate with treatment dispensation system 170 to allow runtime subsystem 180 to generate dispensation information to clinical trial site personnel 30 in order to properly dispense therapy to subject 40. In trials that use titrations, treatment dispensation subsystem 170 may also communicate with titration limiting rules module 147 via path 145 to determine titration eligibility.

As shown in FIG. 1E, runtime subsystem 180 may include a user interface 182 and runtime database 184 to store subject data and information that are input by site personnel 30. Such data and information may include specific treatment arms, dosing factors, titration levels, titration rules, visit schedule, and treatment compositions corresponding to a subject. Runtime subsystem 180 may access dispensation instructions from treatment dispensation subsystem 170 (via arrow 187) and provide subject data and runtime titrations to treatment dispensation subsystem 170 (via arrow 185). In some embodiments of the invention, titration limiting rules module 147 may transmit titration limiting rules to treatment dispensation subsystem 170 (via arrow 145) that allows treatment dispensation subsystem 170 to respond correctly to unscheduled titration requests from runtime subsystem 180.

FIG. 2A is an example of a treatment design interface to configure a treatment design for a clinical trial, according to an embodiment of the present invention. Treatment design interface 200a may include several interfaces, including article type interface 202, treatment composition interface 204, dosing factor interface 206, and titration interface 210. Article type interface 202 may allow designer 20 to designate the type of therapy administered during the clinical trial. Article type interface 202 may also allow for control, comparator, or placebo articles to be defined. Treatment composition interface 204 may allow designer 20 to designate the composition of article types 202 that can be dispensed in any one transaction. Dosing factor interface 206 may allow designer 20 to set up those additional factors that may be taken into account in determining the treatment composition appropriate for a subject. Titration interface 210 may allow a designer to implement titrations and titration rules into a clinical trial design. Titration interface 210 may include additional titration configuration options such as titration level sets 212a and titration limiting rules 213, among others. Examples of possible interfaces may include drop-down boxes, checkboxes, text boxes, or similar configurable interfaces.

FIG. 2B is an example of an interface used to configure titrations within a treatment design of a clinical trial, according to an embodiment of the present invention. In an embodiment, interface 200b may be accessed by navigating through interface 200a. Interface 200b may allow designer 20 to input and configure titration information. Interface 200b may include access to titration interface 210, which may include level setting interface 212b and limiting rules interface 213, among others. Level setting interface 212b may allow designer 20 to configure titration levels that system 100 may implement into a clinical trial design. Level setting interface 212b may include naming interface 214 and titration level set interface 218. Naming interface 214 may enable specific titration level sets to be identified by name. Schedule interface 216 may allow designer 20 to implement a scheduled or unscheduled titration design into the clinical trial system. Titration level set interface 218 may allow designer 20 to implement specific titration values into the clinical trial system.

FIG. 2C is an example of an interface used to configure study visit schedules subsystem 130, according to an embodiment of the present invention. Study visit interface 200c may allow designer 20 to manually or automatically implement titration level sets across scheduled visits. Study visit interface 200c may include several interfaces, including visit set interface 222 and titration scheduling interface 224. Visit set interface 222 may also allow designer 20 to select the number of days between scheduled visits, define the type of visit, or add or remove visits from the schedule. Visit set interface 222 may also allow designer 20 to designate visits according to a schedule across a clinical trial specification. Visit set interface 222 may allow designer 20 to set titration level sets across scheduled visits through titration scheduling interface 224. In an embodiment of the present invention, titration scheduling interface 224 may integrate information selected from titration level set interface 218.

An exemplary interface 200d for treatment assignment subsystem 160 is shown in FIG. 2D. Treatment assignment subsystem 160 may utilize treatment combinations computed by rules engine 150 from other subsystems and modules in dispensation design system 100. Interface 200d may include several subsystem interfaces to facilitate treatment assignment, including arm interface 230, visit interface 240, dosing factor level interface 250 (which, in the embodiment of FIG. 2D, uses weight group as a dosing factor), titration level interface 260, and treatment composition interface 270, for example. (Dosing factor level interface 250 further exemplifies dosing factor module 105 and titration level interface 260 further exemplifies level setting module 141.) Interface 200d may allow a user to filter and assign treatments to rules across multiple treatment arms, schedule visits, treatment compositions, dosing factors, and titration levels, for example. The result is a fully configured clinical trial design specification 162 and treatment dispensation information usable by runtime system 190. The functionality of interface 200d reduces what could comprise tens of thousands of rules and combinations into a handful of selections that are globally assignable. One possible output of interface 200d, an excerpt from a clinical design specification 162, is shown in FIG. 2E. Clinical trial design specification 162 may include information pertaining to arms of the trial, types of visits, titration levels, dosing factors, and treatment compositions. Clinical trial design specification 162 may also include information related to study properties (e.g., blinding restrictions, randomization properties, quarantine settings, dosing rules, and dosing factors), randomization design (e.g., randomization algorithm, treatment inventory, study arm ratio, and randomization factors), and treatment design (in addition to above parameters, conditional titration capability, titration levels, titration limiting rules, and visit schedule).

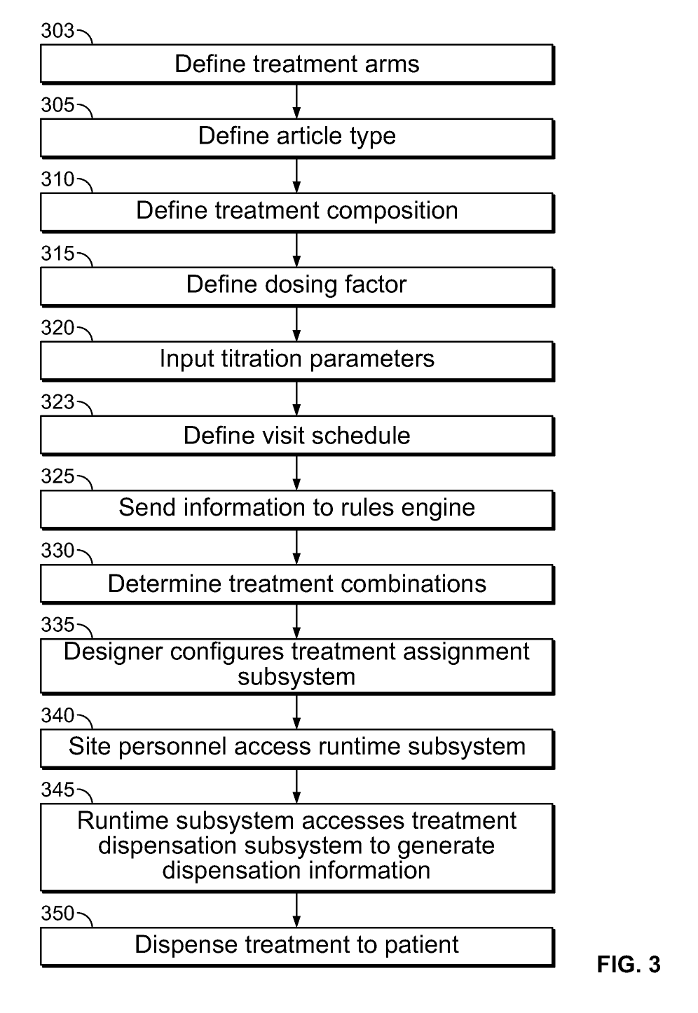

Reference is now made to FIG. 3, which is a flowchart 300 of an embodiment of system 10 for configuring and implementing a clinical trial design. In operation 303, designer 20 may first define study or treatment arms, which may be done using randomization design subsystem 120. In operation 305, designer 20 may then define or select the article type, which may include the type of therapy administered during the clinical trial. In operation 310, designer 20 may define or select the treatment composition, which may include the chemical composition of the therapy used in the clinical trial. Designer 20 may then define or select the dosing factor in operation 315. As mentioned above, a dosing factor may include clinical factors such as a subject's weight or body surface area, or may include more abstract factors such as a subject's dosing level, or a combination of both. A dosing factor may include a factor for randomization. After making the above selections, designer 20 may input titration parameters in operation 320 as well as define a visit schedule in operation 323. At this point, the designer may decide to send information to rules engine 150 in operation 325 to compute treatment combination sets based on treatment parameters. After engaging the rules engine, the system may determine treatment combinations for use in an interactive, configurable treatment assignment subsystem containing treatment parameters in operation 330. In operation 335, a designer may configure the treatment assignment subsystem, for example, to assign specific treatments, dosages, and titration rules to particular subjects and arms of the clinical trial. During the clinical trial, site personnel may access a runtime system (or subsystem), in operation 340, in order to obtain treatment dispensation information or request system permission to dispense. Upon site personnel request, in operation 345, the runtime subsystem accesses treatment dispensation subsystem information to generate dispensation information to site personnel. In operation 350, site personnel dispense treatment to the patient or subject.

Besides the operations shown in FIG. 3, other operations or series of operations are contemplated to configure and implement a clinical trial design. For example, the steps leading to the configuration of the design may involve some iterations until the design is set. Then, the design, after it is set, informs the treatment dispensation subsystem which may dispense instructions to the site personnel which is based on feedback from the subject and site personnel, resulting in dynamic treatment dispensation. Moreover, the actual order of the operations in the flowchart is not intended to be limiting, and the operations may be performed in any practical order.

The parts and blocks shown in FIGS. 1A-1E are examples of parts that may comprise system 10, dispensation design system 100, and runtime system 190 and do not limit the parts or modules that may be included in or connected to or associated with these systems. For example, runtime subsystem 180 and treatment dispensation subsystem 170 are shown as separate blocks, but they may be part of the same runtime system and the functional division may not be visible to the site personnel. Also, there may be overlap in functionality between and among the input subsystems 105-140 and the way they are used as inputs to rules engine 150. Moreover, the interfaces shown in FIGS. 2A-2D are merely examples of interfaces that may be used—more inputs may be used that may implicate other functions within subsystems 105-140 and rules engine 150.

In sum, described herein is a system for managing clinical treatment dispensation that interacts with a runtime treatment system to provide more efficient treatment design than was available before. More steps are performed automatically and human error may be minimized. Moreover, in prior systems, a software developer was needed to code details of the visit schedule, but this system does away with the need for such coding and the treatment designer is able to complete a design in less time and with decreased possibility for error. And although much of the discussion has been directed to the use of system 10 in designing a clinical trial and assigning treatments to subjects in a clinical trial, the system may be used in other scenarios to design treatments for other clinical settings, such as a doctor's office or clinic or hospital, and where the patient may not be a subject in a clinical trial but is being treated by the doctor or hospital.

Aspects of the present invention may be embodied in the form of a system, a computer program product, or a method. Similarly, aspects of the present invention may be embodied as hardware, software or a combination of both. Aspects of the present invention may be embodied as a computer program product saved on one or more computer-readable media in the form of computer-readable program code embodied thereon.

For example, the computer-readable medium may be a computer-readable signal medium or a computer-readable storage medium. A computer-readable storage medium may be, for example, an electronic, optical, magnetic, electromagnetic, infrared, or semiconductor system, apparatus, or device, or any combination thereof.

A computer-readable signal medium may include a propagated data signal with computer-readable program code embodied therein, for example, in baseband or as part of a carrier wave. Such a propagated signal may take any of a variety of forms, including, but not limited to, electromagnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Computer program code in embodiments of the present invention may be written in any suitable programming language. The program code may execute on a single computer, or on a plurality of computers. The computer may include a processing unit in communication with a computer-usable medium, wherein the computer-usable medium contains a set of instructions, and wherein the processing unit is designed to carry out the set of instructions.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

1-18. (canceled)

19. A clinical trial design system for configuring a clinical trial design specification, comprising:
at least one treatment module interface configured to provide treatment configuration options for selection, wherein at least one treatment configuration option comprises titration configuration options, including titration level sets and titration limiting rules;
a rules engine, controlled by a processor, configured to receive selected treatment configuration options, including titration configuration options, and to compute at least one treatment combination set comprising a plurality of treatment parameters, wherein the treatment combination set is based upon the selected treatment configuration options and at least one treatment parameter comprises titration information; and
a treatment assignment interface, comprising the treatment combination set, configured to receive and display the treatment combination set for selection and to generate the clinical trial design specification based upon selections made from said treatment combination set,
wherein the titration limiting rules are used for the duration of the clinical trial and are selected from one or more of enforcing up and down single-step titrations at titration levels set by a user and limiting the number of times a subject may be titrated up or down.

20. The clinical trial design system of claim 19, further comprising a runtime system configured to receive treatment dispensation information from said treatment assignment interface.

21. The clinical trial design system of claim 19, further comprising a runtime system configured to receive data from site personnel.

22. The clinical trial design system of claim 21, wherein said data are selected from the group of visit numbers, requests to titrate, patient data, and dosing factors.

23. The clinical trial design system of claim 19, wherein the at least one treatment module interface is selected from the group consisting of a dosing factor interface, a treatment selection interface, a visit schedule interface, a randomization interface, and a titration design interface.

24. The clinical trial design system of claim 19, wherein the treatment assignment interface is further configured to filter said treatment parameters across treatment arms.

25. The clinical trial design system of claim 24, wherein said treatment parameters comprise treatment arms, schedule visits, treatment compositions, dosing factors, and titration levels.

26. (canceled)

27. (canceled)

28. A non-transitory computer readable storage medium, comprising computer executable instructions embodied therein, to be executed by a computer processor, for:
providing treatment configuration options for selection, wherein at least one treatment configuration option comprises titration configuration options, including titration level sets and titration limiting rules;
receiving selection of treatment configuration options, including titration configuration options;
computing at least one treatment combination set comprising a plurality of treatment parameters, wherein said treatment combination set is based upon selected configuration options;
receiving and displaying the treatment combination set for selection, wherein a treatment assignment interface comprises the treatment combination set, and wherein at least one treatment parameter comprises titration information; and
generating a clinical trial design specification from selections made from said treatment combination set,
wherein the titration limiting rules are used for the duration of the clinical trial and are selected from one or more of enforcing up and down single-step titrations at titration levels set by a user and limiting the number of times a subject may be titrated up or down.

29. The computer readable storage medium of claim 28, further comprising computer executable instructions embodied therein, to be executed by a computer, for providing a runtime system configured to receive treatment dispensation information from said treatment assignment interface.

30. The computer readable storage medium of claim 28, further comprising computer executable instructions embodied therein, to be executed by a computer, for providing a runtime system configured to provide treatment dispensation instructions used in a clinical treatment.

31. The computer readable storage medium of claim 28, further comprising computer executable instructions embodied therein, to be executed by a computer, for transmitting patient data to a runtime system and for revising said treatment dispensation instructions based on said patient data.

32. A method for configuring a clinical trial design specification, comprising:
receiving selected treatment configuration options using at least one treatment module interface, wherein at least one treatment configuration option comprises titration configuration options, including titration level sets and titration limiting rules;
computing, with a processor, at least one treatment combination set comprising a plurality of treatment parameters, wherein the treatment combination set is based upon the selected treatment configuration options, including titration configuration options;
receiving a configured treatment combination set, wherein at least one treatment parameter comprises titration information; and
generating said clinical trial design specification from selections made from said treatment combination set,
ein the titration limiting rules are used for the duration of the clinical trial and are selected from one or more of enforcing up and down single-step titrations at titration levels set by a user and limiting the number of times a subject may be titrated up or down.

33. The method for configuring a clinical trial design specification of claim 32, further comprising generating treatment dispensation information based on input patient data.

34. The method for configuring a clinical trial design specification of claim 33, further comprising modifying treatment dispensation information based on titration limiting rules that limit the ability to titrate a treatment to a patient.

35. A method for configuring clinical trial treatment dispensation, comprising:
receiving selected treatment configuration options using at least one treatment module interface, wherein at least one treatment configuration option comprises titration configuration options, including titration level sets and titration limiting rules;
computing, with a processor, at least one treatment combination set comprising a plurality of treatment parameters, wherein the treatment combination set is based upon the selected treatment configuration options, including titration configuration options;
receiving a configured treatment combination set, wherein at least one treatment parameter comprises titration information;
receiving at a runtime system treatment dispensation information based on said configured treatment combination set;
providing patient data to said runtime system; and
generating treatment dispensation information based on said patient data,
wherein the titration limiting rules are used for the duration of the clinical trial and are selected from one or more of enforcing up and down single-step titrations at titration levels set by a user and limiting the number of times a subject may be titrated up or down.

36. The method for configuring a clinical trial design specification of claim 35, further comprising modifying treatment dispensation information based on titration limiting rules that limit the ability to titrate a treatment to a patient.
